(19) United States
(12) Patent Application Publication
(10) Pub. No.: US 2009/0211109 A1
(43) Pub. Date: Aug. 27, 2009

(54) Dryer and Method for Controlling the Same

(75) Inventors: Soung-Bong Choi, Kyungsangnam-do (KR); Hyeok Deok Kim, Kyungsangnam-do (KR); Deug Hee Lee, Kyungsangnam-do (KR); Seong Hae Jeong, Kyungsangnam-do (KR); Hung Myoung Cho, Kyungsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/920,845

(22) PCT Filed: May 22, 2006
(86) PCT No.: PCT/KR2006/001918

§ 371 Date: Mar. 23, 2009

(30) Foreign Application Priority Data
May 23, 2005 (KR) 10-2005-0042897
May 23, 2005 (KR) 10-2005-0042898

(51) Int. Cl. F26B 3/02; D06F 58/04; F26B 21/08

(52) U.S. Cl. 34/491; 34/130; 34/557

(57) ABSTRACT

A dryer according to the present invention includes a dry drum for loading the laundry; a driving motor driving the dry drum; and a steam generator installed at a side of the exterior of the dry drum and generating steam.

### TECHNICAL FIELD

The present invention relates to a dryer, particularly, to a dryer combined with a steam generator, supplying water enough to iron the wrinkled clothes or other laundry or removing wrinkle in the process of drying, and a method for controlling the same.

### BACKGROUND ART

In general, the dryer is a home electric appliance drying the laundry by putting the laundry completed laundry and spin-dry process into the dry drum, and then, evaporating water soaked through the laundry by blowing hot wind to the inside of the dry drum.

In detail, the dryer comprises a dry drum loaded the laundry, a driving motor driving the dry drum, a blowing fan blowing air into the drum, a heating part heating the air flowing into the dry drum herein. The heating part is classified into an electric-type using the high-temperature heat of the electric resistance generated by heating hot wire and a gas-type using the heat generated by gas combustion.

Further, a general dryer is classified into a condensing-type dryer which makes the high temperature and humid air generated while drying the wet clothes circulate therein and exchange heat with surrounding air in a condenser and an exhausting-type dryer which makes the high temperature and humid air directly exhausted to the out side thereof.

Meanwhile, in case of completing laundry, some consumers do not bring out the laundry at once and they let the laundry stay in the wash drum for hours. In this case, the laundry becomes excessively wrinkled because the process of spin-drying is performed with the laundry being stuck to the inner surface of the drum.

Particularly, clothes such as dress shirt need to be ironed or re-washed and re-dried even after drying completion.

In this case that the wrinkled laundry occurs too much, it demands a device or a course that easily removes the wrinkle and returns the laundry to a proper condition to do the ironing.

### DISCLOSURE OF INVENTION

### Technical Problem

An object of the present invention is proposed to provide to offer the dryer and the method for controlling the same capable of removing wrinkle easily and returning to the proper condition to do the ironing when the laundry becomes dried with excessively being wrinkled after completion of laundry process.

### Technical Solution

A dryer according to the present invention to achieve these purpose, as described herein, includes a dry drum for loading the laundry; a driving motor driving the dry drum, the steam generator installed at a side of the exterior of the dry drum and generating steam.

Another aspect of a dryer according to the present invention includes a cabinet; a dry drum installed in the cabinet; a steam generator installed between the dry drum and the cabinet and generating steam; a steam supplying portion connecting the steam generator with the dry drum.

Further, a method for controlling the dryer according to the present invention to achieve these purpose, as described herein, is that steam is supplied into the drum to dry the laundry in a flattened condition in drying process.

Another aspect of the method for controlling the dryer according to the present invention includes: putting the laundry into the inside of the drum and supplying steam; rotating the drum with steam supplying; and driving the heater and/or the drying fan continuously or occasionally with supplying steam.

### Advantageous Effects

In accordance with the dryer combined with the steam generator and method for controlling the same according to the present invention, a user can the wrinkle of the laundry easily removed, even if the laundry is dried in a crumpled condition to become excessively wrinkled.

Moreover, even in case that too much amount of the wrinkled clothes are generated at a time, it is possible to easily and effectively remove wrinkle from the laundry and change into the condition do the ironing through the steam drying process.

### BRIEF DESCRIPTION OF THE DRAWINGS

FIG. 1 is a cross-sectional view of side showing a dryer having a steam generating device according to the concept of the present invention.

FIG. 2 is a perspective view showing an inner structure of the dryer.

FIG. 3 is an exterior perspective view broadly showing a steam generator installed in the dryer according to the concept of the present invention.

FIG. 4 is a cross-sectional view of side, cut away a section cross a line I-I′ in FIG. 3.

FIG. 5 is another embodiment of a steam generator installed at the dryer according to the concept of the present invention.

FIG. 6 is a cross-sectional view of side, cut away a section cross a line II-II′ in FIG. 5.

FIG. 7 is a flowchart showing the first embodiment of the stream drying process according to the concept of the present invention.

FIG. 8 is a flowchart showing the second embodiment of the stream drying process according to the concept of the present invention.

FIG. 9 is a flowchart showing the third embodiment of the stream drying process according to the concept of the present invention.

### BEST MODE FOR CARRYING OUT THE INVENTION

Hereinafter, description will be made in detail to the preferred embodiments of the present invention with reference to the drawings. However, the present invention is not limited thereto by the preferred embodiments, and by addition to other elements, modification, elimination etc., it can be proposed easily another embodiment included the range of the another retrograde invention or the concept of the present invention

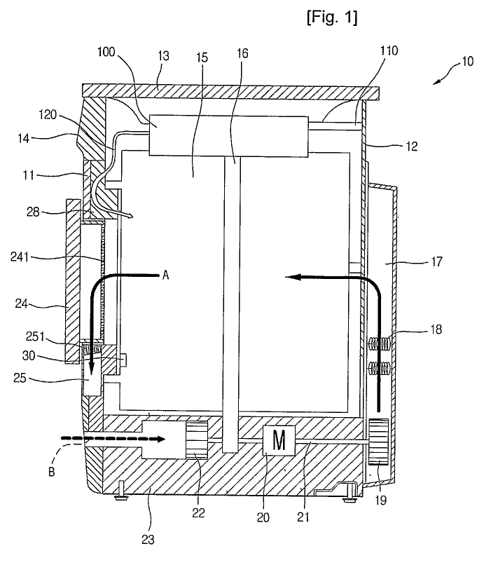

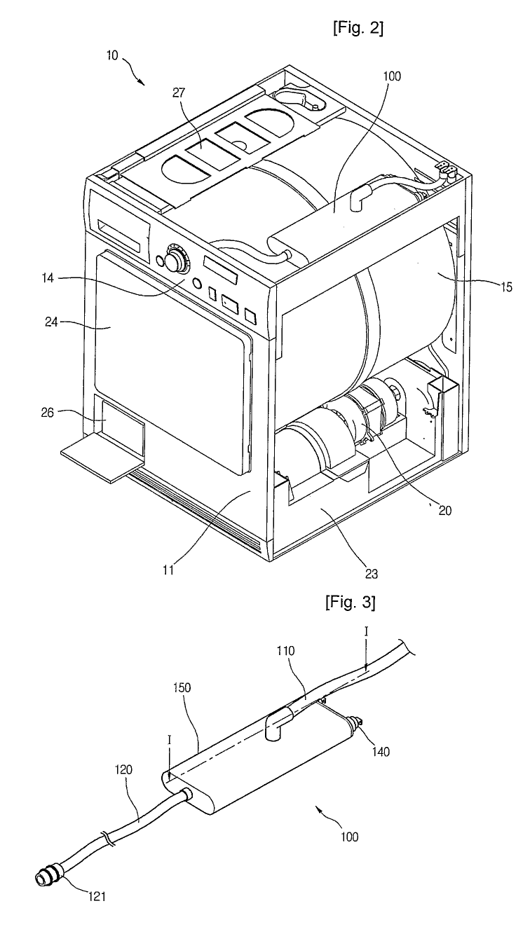

FIG. 1 is a cross-sectional view of side showing a dryer having a steam generating device according to the, concept of the present invention, and FIG. 2 is a perspective view showing an inner structure of the dryer.

Herein, for illustrating the dryer according to the concept of the present invention, a condensing-type dryer is explained with an example. However, the concept of the present invention is possible to apply not only a condensing-type, but also an exhausting-type dryer.

Referring FIG. 1 and FIG. 2, the clothing dryer 10 having the steam generator according to the present invention includes a dry drum 15 loaded the laundry, a front cover 14 protecting the dry drum and forming an exterior, a back cover 12 and a top cover 13.

In detail, the dryer 1 comprises a support cover 28 installed at a back side of the front cover 11 and supporting a front opening portion of the dry drum 15, a door 24 installed on the front side of the front cover 11 and opening and closing an opening of the dry drum 15, and a control panel 14 installed at an upper portion of the front cover 11 and having a plural buttons for inputting a drying condition.

Further, the dryer 1 comprises a drying fan 19 circulating the air inside of the dry drum 15 in the dryer 1, a drying duct 17 guiding to introduce the flowing of the circulating air which passes the dry drum 15 to the inside of the dry drum 15 by the drying fan 19, a heater 18 installed at an inner portion of the drying duct 17 to raise the temperature of the air introduced into the dry drum 15, a steam generator 100 installed at a side of the exterior of the dry drum 15 and generating steam, a drain hose supplying ambient temperature water to the steam generator 100, and a steam nozzle 120 spraying steam generated by the steam generator 100 to the dry drum 15 inside. At a side of the supporter cover 28 is installed a humidity sensor 30 for sensing humidity of the inside of the dry drum 15.

Further, underneath the dry drum 15 is installed a base 23 in which a channel of circulating air A and a channel of indoor air B for heat-exchange with the circulating air are respectively formed. At an upper portion of the base 23 is installed a driving motor 20 driving the dry drum 15. The rotatory power occurred by the driving motor 20 is transferred to the dry drum 15 by a belt 16 enclosed at the outside of the dry drum 15. A cooling fan 22 inhaling the indoor air is connected to the motor shaft 21 of the driving motor 20 and to the motor shaft of the opposite side of the cooling fan 22 is connected the drying fan 19. At a side of the base 23 inside is installed a condenser 26 to make indoor air and circulating air heat-exchange.

To explain the steam drying process of the condensing-type dryer 10 according to the present invention broadly, firstly, a user opens the door 24 and loads the laundry in the dry drum 15. The user inputs the steam drying course through the input section installed at the control panel 14, and presses the operation button to let drying start. Then, water is supplied through the drain hose 110 to the steam generator 100, and the water supplied is heated by the heater installed in the inside of the steam generator 100. The steam generated at the steam generator is introduced through the steam nozzle 120 to the inside of the drum 15.

Meanwhile, when drying process starts, the driving motor 20 works and the dry drum 15 is rotated by the rotation of the belt rolled around the circumference of the dry drum 15 and the motor shaft 21. Herein, when the driving motor 20 rotates, it can drives the cooling fan 22 and the drying fan 19 together or selectively.

Further, the heater 18 installed in the drying duct 17 let the temperature of air flowing into the dry drum 15 rise. Herein, it is desirable to be controlled by a control part of the dryer 1 whether the heater 18 operates or not according to the general drying process and steam drying process. In detail, although the dry drum rotates at the steam drying process, if it is not approved the electric current to be supplied to the the heater 18, the operation of the heater 18 can be controlled by the control part.

Further, as the drying fan 19 operates, the circulating air flowing in the dry drum 15 moves through the door lint filter 240 installed in the door 24 to the circulating channel 25. The lint is filtered out while it passes through the door lint filter and the body lint filter 251 installed at the entrance of the circulating channel 24. The circulating air moving through the circulating channel 25 moves to the condenser 26. The indoor air inhaled by the cooling fan 22 also moves to the condenser 26. The temperature of the circulating air goes down by the condenser 26, and moisture contained in the circulating air is condensed. The condensed moisture is gathered at the condensed water storage portion 27 installed at an outside of the dry drum. The indoor air inhaled by the cooling fan 22 passes through the condenser 26 and is discharged to indoor again.

Herein, it is desirable that the drying fan 19, the cooling fan 22 and the beater 18 etc. must be controlled by the control part whether they operate or do not operate according to the kind of drying course.

Meanwhile, when a user choose the steam drying course, details about a process occurred in the dryer 10 will be explained together with the flowchart.

FIG. 3 is an exterior perspective view broadly showing a steam generator installed in the dryer according to the concept of the present invention, and FIG. 4 is a cross-sectional view of side, cut away a section cross a line I-I′ in FIG. 3.

Referring FIG. 3 and FIG. 4, the steam generator 10 located in the dryer according to the present invention generates steam by tube heating method.

In detail, the steam generator comprises a case 150, a steam generating tube 130 installed in the case 150 and letting water and steam flow and a heater 140 heating the water flowing through the inside of the steam generating tube 130 and steaming up the water.

More particularly, at a side of the steam generator 100 is installed a drain hose 110 connected to the steam generating tube and supplying water. At another side of the steam generator 100 is installed a steam hose 120 discharging steam evaporating in the inside of steam generating tube 130. The steam hose 120 is connected to the other side of the steam generating tube 130. At an end of the steam hose 120 is installed a steam discharging port 121 spraying steam. The steam outlet 121 is installed at the front or the rear portion of the dry drum 15 and sprays steam into the dry drum 15 Herein, the steam discharging portion 121 is formed to a shape of pipe of which diameter is uniform. Therefore, it can spread steam to the inside of the dry drum 15 in an atomizing condition. Otherwise, the steam discharging portion 121 is formed to a shape of nozzle of which the diameter becomes narrower. Therefore, the steam can be sprayed to the inside of the dry drum 15 with a predetermined pressure.

By the steam generator, the water supplied through the drain hose 110 moves through the steam generating tube 130 installed long in the case 150. In this process, heat generates out of the heater 140 installed at a circumference of the steam generating tube 130 and heats water flowing through the inside of the steam generating tube 130.

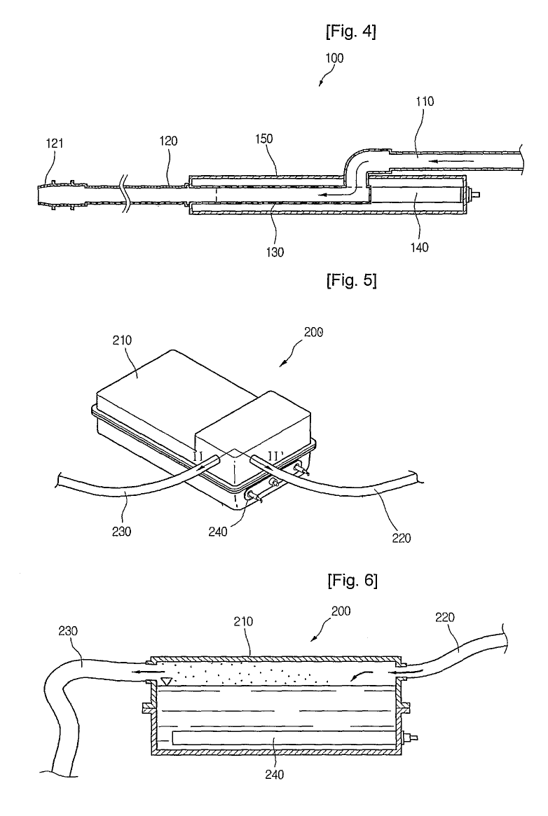

FIG. 5 is another embodiment of a steam generator installed at the dryer according to the concept of the present invention, and FIG. 6 is a cross-sectional view of side, cut away a section cross a line II-II′ in FIG. 5.

Referring FIG. 5 and FIG. 6, the steam generator 200 installed at the dryer 10 according to the present invention comprises a water chamber 210 holding water and steam inside, a heater 240 installed in the water chamber 210, a drain hose 220 connected to a side of the water chamber 210 and supplying water, a steam hose 230 connected to an opposite side of the water chamber 210 and generating steam.

In detail, steam generator 200 formed as above stated uses a tub heating method, storing a predetermined amount of water in the predetermined size of water chamber 210, and then, heating the water with the heater 240 and generating steam. More particularly, the steam generator 200 using the tub-heating method is that water and steam are stored in the water chamber 210 as it is illustrated, and steam is only discharged through the steam hose 230, there is an advantage that steam is evenly dispensed in the dry drum 15.

Meanwhile, as above mentioned, the steam discharging portion installed at an end of the steam hose 120, 230 can be located at a front side or a rear side of the dry drum 15 and can spray steam to the front or the rear side of the drum. The shape of the steam discharging portion can be applied as the same as that above mentioned.

When the steam generators as above mentioned are installed in the dryer and let steam flow in the dry drum, it can be prevented the clothes from being wrinkled in the process of drying.

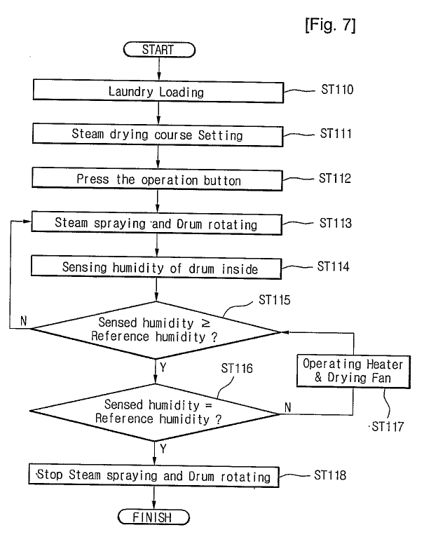

FIG. 7 is a flowchart showing the first embodiment of the stream drying process according to the concept of the present invention.

Referring FIG. 7, it is a process that the laundry dried in a crumpled condition passes through a steam drying process to make the wrinkle eliminated.

Firstly, a user loads the wrinkled dry laundry inside the drum ST110. The user input steam drying course with a button installed at the control panel 14 ST111, and presses the operation button ST112. Then, steam is discharged from the steam discharging portion installed at the front side or the back side of the dry drum together with the dry drum 15 being rotated ST113. Herein, steam is sprayed or spread in the dry drum 15 at the same time drum rotating, and steam is soaked into the laundry evenly. The humidity of the dry drum inside formed by the steam discharging to the inside of the dry drum 15 is determined by the humidity sensor 30 ST114.

The value of the humidity determined by the humidity sensor 30 is transmitted to the controlling part, and compared with the reference value in the controlling part ST115.

Meanwhile, if the value of the humidity measured by the humidity sensor is lower than that of the reference humidity, steam is continuously generated, and it is estimated whether the value of the measured humidity is equal to the reference humidity or not ST116. If the value of measured humidity is equal to that of the reference humidity, steam spraying is stopped, and rotation of the drum is stopped ST118. Finally, the steam drying process is finished.

On the contrary, if the value of measured humidity is higher than that of the reference humidity, the heater 18 to heat the air introduced into the dry drum is operated, at the same time, drying fan 19 introducing the heated air into the dry drum 15 is operated ST117. That is, dry process is performed until the value of the humidity in the dry drum reaches to that of the reference humidity.

Furthermore, the humidity is measured by the sensor of the humidity, and the process of comparing and judging the dimension of the value of the humidity is repeatedly performed in the control part.

By the process mentioned above, completely dried and much wrinkled laundry go through steam drying so that the wrinkle of the laundry can be removed and the laundry can be maintained in a state to easily iron. Furthermore, there is an advantage that, in the steam drying process, the inside of the dry drum is uniformly maintained at the reference humidity state so that optimal ironing condition of the clothes can be acquired.

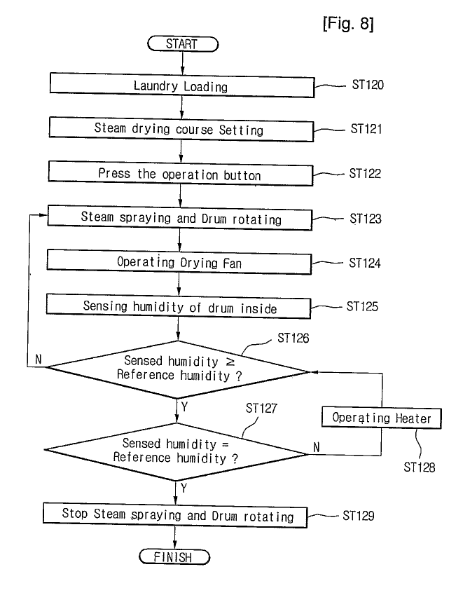

FIG. 8 is a flowchart showing the second embodiment of the stream drying process according to the concept of the present invention.

Referring FIG. 8, the steam drying process showed in the embodiment that a user loads the laundry into the dry drum 15 ST120 and sets up the steam drying course ST121 and then, presses the operation button ST122 to perform the steam spraying and rotating process of the dry dram 15 ST123 is the same as the first embodiment above.

In detail, the present embodiment has a difference from the first embodiment, in the case that steam is discharged inside the dry drum 15, when the dry drum rotates and the drying fan 19 drives at the same time. That is to say, in order that steam sprayed from the steam discharging portion spread inside the drum regularly and soaks into the cloth, the indoor air of the dry drum should circulate and form turbulent flow. To achieve this, besides the method letting the cloth rise and fall over the rotation of the dry drum 15, air is blown into the drum, and then, air circulates smoothly.

Therefore, in the steam spraying process, the rotating of the drying fan 19 let the circulating air flow into the dry drum 15, and steam sprayed and circulating air are mixed. Steam is also soaked into the cloth in a short time by letting turbulent flow rise in the dry drum.

Herein, according to the case that the steam discharging portion is installed at the front side of the dry drum 15 or the case that the steam discharging portion is installed at a rear side of the dry drum, steam flows to a direction in accordance with or to an opposite direction to the inflow direction of circulating air. Therefore, according to the position of the steam discharging portion, intensity of turbulence can be different.

Meanwhile, in the process of spraying steam inside the dry drum 15 and of driving the drying fan 19, humidity of inside the dry drum is estimated by the humidity sensor 30 ST125 and the value of the humidity in the dry drum is compared to that of the reference humidity by the control part ST126. If the value of estimated humidity is lower than the that of the reference humidity, steam is sprayed continuously. If the value of estimated humidity is judged as same as that of the reference humidity, it performs a process that the steam spraying and rotating drum is stopped ST127,ST129. Of course, it is preferable that the driving of the drying fan is stopped together at the process that the steam spraying and rotating drum is stopped ST129.

On the contrary, the value of estimated humidity is higher than the that of the reference humidity, the heater installed in the drying duct 17 drives ST128 and the drying process is performed. That is to say, if the heater 18 works in the process of the driving the drying fan 19, hot and dry air flows into the dry drum. Moisture soaked into the laundry in the dry drum 15 is evaporated. It is intended for the inside of the dry drum 15 to be uniformly maintained in a reference humidity condition.

Herein, in the process of driving the heater and performing the laundry drying, the humidity of the drum inside is estimated in every moment, and at the same time is compared and judged with the reference humidity by the control part.

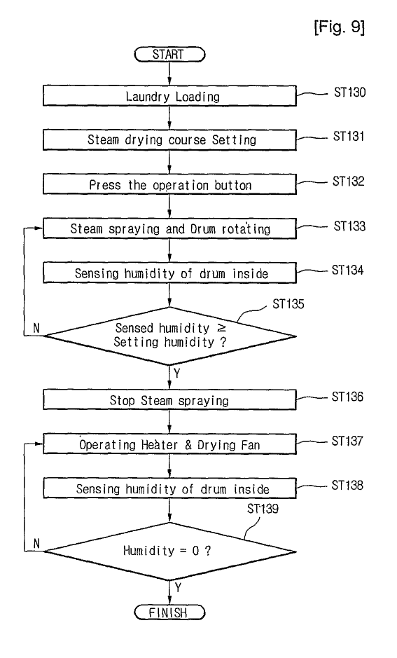

FIG. 9 is a flowchart showing the third embodiment of the stream drying process according to the concept of the present invention.

Referring FIG. 9, this embodiment is characterized in that wrinkle of the laundry becomes flattened by spraying steam inside the drum, and till the laundry is dried completely, the drying process is performed.

In detail, when the wet laundry is dried naturally in the dry drum, the laundry becomes excessively crumpled. However, it is an advantage that the laundry is effectively dried and less wrinkled when the laundry is loaded in the dry drum in a bit moist condition and is dried. Therefore, the wrinkle occurred on the laundry is remarkably reduced when the completely dried and wrinkled laundry is put into the dryer and becomes a little bit moist therethrough steam spraying, and then, drying process is performed once more.

Therefore, the completely dried and wrinkled laundry is put into the dryer and becomes a little bit moist through steam spraying, and then, drying process is performed once more, wrinkle occurred on the cloth is reduced remarkably.

To achieve the purpose and effect, firstly, a user puts the laundry into the dry drum 15 ST130, and sets up the steam drying course ST131. When the user presses the operation button ST132, steam is sprayed while the dry drum 15 rotates ST133. During the above process performs, humidity of the dry drum 15 inside is estimated every moment by the humidity sensor 30 ST134. Steam is sprayed until the degree of sensed humidity estimated by the humidity sensor 30 gets higher than or equal to that of reference humidity.

Meanwhile, if the degree of estimated humidity is proved to be higher than that of reference humidity by the control part, steam spraying is stopped ST136. After that, a general drying process is performed by the driving of the dryer fan and the heater ST137. Furthermore, the drying process is continued until the humidity in the dry drum becomes zero ST139.

When the laundry is completely dried, the steam drying process is finished by stopping the operation of the drying fan, the heater and the driving motor.

### INDUSTRIAL APPLICABILITY

Occurrence of wrinkle in the process of drying the laundry remarkably reduced by the present invention, as well as, the laundry dried as it was wrinkled changes into the easier condition to do the ironing, consumer satisfaction is increased. Therefore, industrial availability of this invention is very high.

1. A dryer comprising:
a dry drum for loading the laundry
a driving motor driving the dry drum; and
a steam generator installed at a side of the exterior of the dry drum and generating steam.

2. The dryer according to claim 1, wherein the steam generator is a tube heating type heating water flowing into the tube and discharging the water as steam to the inside of the dry drum.

3. The dryer according to claim 1, wherein the steam generator is a tub heating type heating water stored in a water container, and discharging the water as steam to the inside of the dry drum.

4. The dryer according to claim 1, further comprising a steam discharging portion installed at a side of the dry drum and making steam spread under the atomized condition or spraying steam to a predetermined pressure to the inside of the dry drum.

5. The dryer according to claim 1, further comprising a steam discharging portion, installed at a front or rear side of the dry drum.

6. The dryer according to claim 1, wherein the steam generated by the steam generator flows alone or together with air into the dry drum.

7. The dryer according to claim 1, further comprising a humidity sensor sensing the humidity of the dry drum inside.

8. A dryer comprising:
a cabinet;
a dry drum installed in the cabinet;
a steam generator installed between the dry drum and the cabinet and generating steam; and
a steam supplying portion connecting the steam generator with the dry drum.

9. The dryer according to claim 8, wherein the steam supplying portion comprises a hose for moving steam generated by the steam generator, a steam discharging portion connected to an end portion of the hose and installed at a predetermined side of the dry drum.

10. The dryer according to claim 9, wherein a steam discharging portion is installed at a predetermined side of the dry drum and steam is discharged to a direction in accordance with the air flow in the dry drum.

11. The dryer according to claim 9, wherein the steam discharging portion is installed at a predetermined side of the dry drum and steam is discharged to a direction opposite to the air flow in the dry drum.

12. The dryer according to claim 8, wherein the steam generator comprises a steam generating tube, and a heater installed at least adjacent to an exterior of the steam generator and heating water flowing through the inside of the generating tube.

13. The dryer according to claim 8, wherein the steam generator comprises a case for water storing, and a heater installed in the case and heating water.

14. A method for controlling the dryer characterised in that steam is supplied into the drum to dry the laundry in a flattened condition in drying process.

15. The method for controlling the dryer according to claim 14, wherein in the process of supplying steam, humidity of the drum inside is estimated in a predetermined intervals.

16. The method for controlling the dryer according to claim 14, wherein circulating air and steam flow together into the drum to form turbulence.

17. The method for controlling the dryer according to claim 14, wherein hot wind is supplied according to the humidity of the drum inside.

18. The method for controlling the dryer according to claim 14, wherein if the humidity of the drum inside is maintained under the reference humidity condition, steam supplying is stopped.

19. The method for controlling the dryer according to claim 14, wherein steam is supplied until the humidity of the drum inside is higher than a reference humidity, and then hot wind is supplied until the humidity of the drum inside becomes 0.

20. A method for controlling the dryer including:
putting the laundry into the inside of the drum and supplying steam;
rotating the drum with steam supplying; and
driving the heater and/or the drying fan continuously or occasionally with supplying steam.

21. The method for controlling the dryer according to claim 20, wherein humidity of the drum inside is estimated in a predetermined intervals and the humidity of the drum inside is compared and judged with a reference humidity.

22. The method for controlling the dryer according to claim 21, wherein if the humidity of the drum inside is higher than the reference humidity, steam supplying is stopped and at least one of the heater and the drying fan drives.

23. The method for controlling the dryer according to claim 22, wherein at least one of the heater and the dryer fan drives until the humidity of the drum inside reaches to the reference humidity or 0.

24. The method for controlling the dryer according to claim 21, wherein if the humidity of the inside of the drum is higher than the reference humidity, at least one of the heater and the drying fan drives together with steam supplying.

25. The method for controlling the dryer according to claim 21, wherein if the humidity of the drum inside is equal to the reference humidity, the drum, the heater and the drying fan stop driving.
